(19) United States
(12) Patent Application Publication
(10) Pub. No.: US 2014/0353533 A1
(43) Pub. Date: Dec. 4, 2014

(54) STACKED SOLENOID OPERATED LINEAR ACTUATOR TUBE

(71) Applicant: Parker-Hannifin Corporation, Cleveland, OH (US)

(72) Inventor: William F. Guse, JR., Glen Ellyn, IL (US)

(73) Assignee: Parker-Hannifin Corporation, Cleveland, OH (US)

(21) Appl. No.: 14/293,692

(22) Filed: Jun. 2, 2014

Related U.S. Application Data
(60) Provisional application No. 61/830,099, filed on Jun. 1, 2013.

(51) Int. Cl. F16K 31/06

(52) U.S. Cl. CPC F16K 31/0655
USPC 251/129.15; 29/890.124

(57) ABSTRACT

A tube assembly for a solenoid operated cartridge valve includes an adapter having an axially extending central bore along a longitudinal axis of the tube assembly for receiving an armature; a plug axially aligned with the central bore of the adapter; a nonmagnetic tube having a central bore along the longitudinal axis and aligned with the central bore of the adapter, the tube having a pair of respective annular axially-facing end surfaces abutting the adapter and the plug, the end surfaces being obliquely angled with respect to the longitudinal axis; and filler material positioned between and joining the adapter and the tube, and the tube and the plug.

### Related Applications

This application claims the benefit of U.S. Provisional Application No. 61/830,099 filed Jun. 1, 2013, which is hereby incorporated herein by reference.

### FIELD OF INVENTION

The present invention relates generally to valve actuators, and more particularly to stacked solenoid operated linear actuators.

### BACKGROUND

Many hydraulic valves are wet-type armature solenoids, where system fluid is contained by a tube. The armature moves in the fluid within the tube. The solenoid creates the magnetic force to move the armature so that no external seal is required between the actuator and the spool or poppet it moves. The lack of a seal eliminates any friction and force unbalance due to pressure acting against the area of the seal. Therefore, there is no reduction in the force available from the actuator. U.S. Pat. No. 4,194,173 discusses these issues. Early designs used brass tubes held together with tie rods which then evolved to brazed non-ferritic stainless and low carbon steel tubes. Welding the tubes is also known. As the force requirements have increased due to higher pressure requirements, the losses in force due to the need for the flux to jump these gaps drove the need for larger solenoid coils to make up for the loss of force. U.S. Pat. No. 4,194,173 shows some improvements to eliminate the gaps.

Inlay style tube assemblies were originally developed for proportional valves and then evolved to the on/off solenoid valves. U.S. Pat. No. 5,986,530 shows a typical inlay style tube. These are made from a solid piece of low carbon steel. A groove is formed in the blank that then gets filled with a bronze material in a welding process or a different type of metal deposition operation. After welding, the excess material is removed to form a tube with a non-magnetic section. This gap is needed to prevent shunting of the flux over the airgap of the armature. This design helped increase the available force by eliminating the airgaps. A bronze material was chosen with a lower melting point to limit the distortion due to the welding operation. The shape of the joint helps focus the flux and enhance force. U.S. Pat. No. 5,986,530 goes into detail on how the inlay tube is constructed and used.

### SUMMARY OF INVENTION

Brazed style tubes typically used a section of stainless tubing with lap joints on each end. These were limited due to the losses in force as the tube size increased to handle higher pressures. The lap style joints did not provide a benefit to help direct the flux at the airgap.

Inlay style tubes improved control of the force output by making only a small section of the tube non-magnetic. However, the formation of the joint through welding created a potential for porosity that reduces the cycle life of the tube or allows external leakage and the use of the bronze material results in lower tensile properties. Further, stainless materials cannot be welded into the groove because the higher melting temperature would distort the angles of the joint and create variation on the force output.

Exemplary tubes, in contrast, provide the benefits of the inlay style tube—with flux traveling through the wall of the tube, focus of the flux lines at the air gap, and a smooth transition between sections of the tube—with the processing ease of production of conventional brazing equipment. The stacked and brazed tube also allows for a full stainless steel construction for use on applications where bronze materials are attacked by the hydraulic fluids or external environment.

According to one aspect of the invention, a tube assembly for a solenoid operated cartridge valve includes an adapter having an axially extending central bore along a longitudinal axis of the tube assembly for receiving an armature; a plug axially aligned with the central bore of the adapter; a nonmagnetic tube having a central bore along the longitudinal axis and aligned with the central bore of the adapter, the tube having a pair of respective annular axially-facing end surfaces abutting the adapter and the plug, the end surfaces being obliquely angled with respect to the longitudinal axis; and filler material positioned between and joining the adapter and the tube, and the tube and the plug.

Optionally, an angled end surface of the adapter abuts one of the end surfaces of the tube and extends from an outer diameter surface to an inner diameter surface that defines the bore of the adapter.

Optionally, the annular end faces are angled at 45 degrees with respect to the longitudinal axis.

Optionally, the annular end faces are angled so as to face radially inward towards the longitudinal axis.

Optionally, the filing material is copper.

Optionally, the adapter is a low carbon steel or a martensitic stainless steel.

Optionally, the plug is a low carbon steel or a martensitic stainless steel.

Optionally, the tube is austentitic stainless steel.

Optionally, joints between the adapter and the tube and between the tube and the plug are stacked joints.

Optionally, the tube assembly includes a second tube axially spaced from the other tube, and the tube assembly is a push/pull tube assembly.

According to another aspect of the invention, a method of making a tube assembly for a solenoid operated cartridge valve includes forming a pre-brazed assembly by assembling in respective axial order an adapter, a tube, and a plug; brazing the pre-brazed assembly to form a brazed assembly, wherein the tube includes a pair of respective annular axially-facing end surfaces abutting the adapter and the plug, the end surfaces being obliquely angled with respect to a longitudinal axis of the tube assembly.

Optionally, the method includes placing filler material on an inner diameter of the tube between the tube and the adapter.

Optionally, the method includes placing filler material on an inner diameter of the tube between the tube and the plug.

Optionally, the filler material is copper.

Optionally, the filler material includes a metal ring.

Optionally, the adapter is a low carbon steel or a martensitic stainless steel.

Optionally, the plug is a low carbon steel or a martensitic stainless steel.

Optionally, the tube is austentitic stainless steel.

Optionally, the assembling includes retaining the assembly with a bolt.

Optionally, the method includes the step of machining away a retaining bolt.

Optionally, the assembling includes retaining the assembly by screwing the plug into the adapter.

Optionally, includes the step of machining the tube from a single piece of nonmagnetic material.

Optionally, the step of forming the pre-brazed assembly further includes trapping the brazing elements above respective joints between the plug and the tube and between the tube and the adapter.

Optionally, the method includes machining at least one of the outer diameter or the inner diameter of the brazed assembly.

Optionally, machining include smoothing brazed joints between the plug and the tube and between the tube and the adapter.

According to another aspect of the invention, a method of making a tube assembly for a solenoid operated cartridge valve includes forming a pre-brazed assembly by assembling in respective axial order an adapter, a tube, and a plug; brazing the pre-brazed assembly to form a brazed assembly; and machining at least one of the outer diameter or the inner diameter of the brazed assembly.

Optionally, forming the pre-brazed assembly further comprises positioning a first filler material between the adapter and the tube and a second filler material between the tube and the plug portion.

Optionally, the first and second filler materials are copper.

Optionally, the first and second filler materials are rings.

Optionally, the adapter is a low carbon steel or a martensitic stainless steel.

Optionally, the plug is a low carbon steel or a martensitic stainless steel.

Optionally, the tube is austentitic stainless steel.

Optionally, the machining includes smoothing brazed joints between the plug and the tube and between the tube and the adapter.

Optionally, the assembling includes retaining the assembly with a bolt.

Optionally, the method includes the step of machining away a retaining bolt.

Optionally, the method includes the step of machining the tube from a single piece of nonmagnetic material.

Optionally, the step of forming the pre-brazed assembly further includes trapping the filler materials above respective joints.

The foregoing and other features of the invention are hereinafter described in greater detail with reference to the accompanying drawings.

### BRIEF DESCRIPTION OF THE DRAWINGS

FIG. 1 shows an exemplary stacked-joint solenoid assembly;

FIG. 2 shows an exemplary solenoid tube assembly before brazing and machining steps retained via a bolt;

FIG. 3 shows an exemplary solenoid tube assembly after brazing and machining steps;

FIG. 4 shows another exemplary solenoid tube assembly before brazing and machining steps having a screwed connection;

FIG. 5 shows another exemplary solenoid tube assembly having a second tube portion axially spaced from the first.

### DETAILED DESCRIPTION

Solenoid operated valves, cartridge valves in particular, have continued to be rated at increasingly higher pressures where the solenoid tube is exposed to the same high pressure. Current mobile hydraulic valves see pressures to 5000 PSI and the trend is for higher pressures. The higher pressures require that the tube be able to contain the high pressure over repeated cycles and be able to communicate a high force to the spool or poppet they actuate. The same high pressures increase the force required from the solenoid due to pressure acting on an area of a poppet or flow forces on a spool.

As mentioned above, exemplary tube assemblies have the benefits of an inlay tube design with the proven technology of brazing dissimilar metals along with a unique method of fixturing.

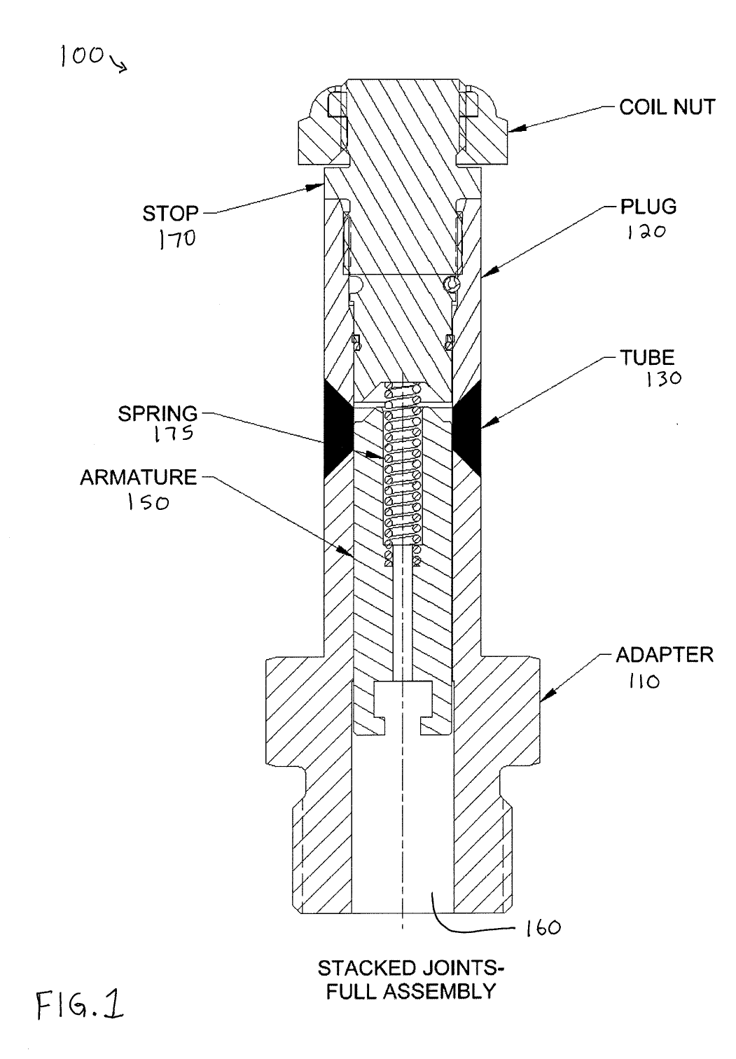

Referring first to FIG. 1, a tube assembly is shown at 100 and includes an adapter 110, a plug 120, and a tube 130. The basic workings of conventional solenoids are well known in the art, and therefore the details of operation are omitted herein for brevity.

The adapter 110 may be made from a low carbon steel or a martensitic stainless steel. For example, 400 series steel may be used.

The plug 120 may similarly be made from low carbon steel or martensitic stainless steel. For example, 400 series steel may be used.

The tube 130 may be made of austenitic (non-magnetic) stainless steel or other nonmagnetic material, for example brass or bronze. In some embodiments, for example, 303 or 304 stainless steel may be used.

The armature or plunger 150 within the assembly is also made from low carbon steel or martensitic stainless steel. Low carbon steel is chosen due to its ability to be magnetized when an electromagnet or solenoid coil is energized and releases the magnetism when de-energized. Martensitic stainless steels that behave like low carbon steel are also often used.

The armature 150 is received in a central bore 160 of the assembly, and travels, in the orientation depicted, vertically toward and away from the stop 170, which is herein depicted as being screwed into the plug.

Spring 175 biases the armature away from the stop 170, and so the armature moves against this biasing force toward the stop when activated. It is understood that this pull-type solenoid depicted is not limiting. Other exemplary solenoids may be push-type solenoids, for example.

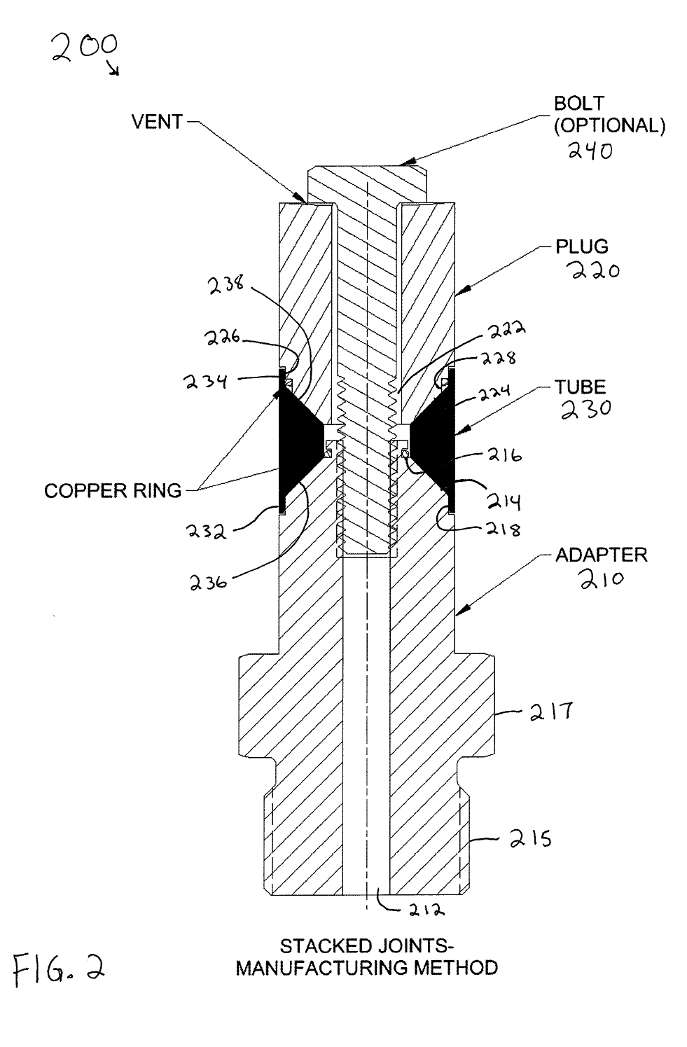

Referring now to FIG. 2, shown at 200 is a tube assembly shown before brazing operations and before machining of the assembly. The adapter 210, tube 230, and plug 220 may be stacked together in the same sequence as a conventional brazed tube assembly.

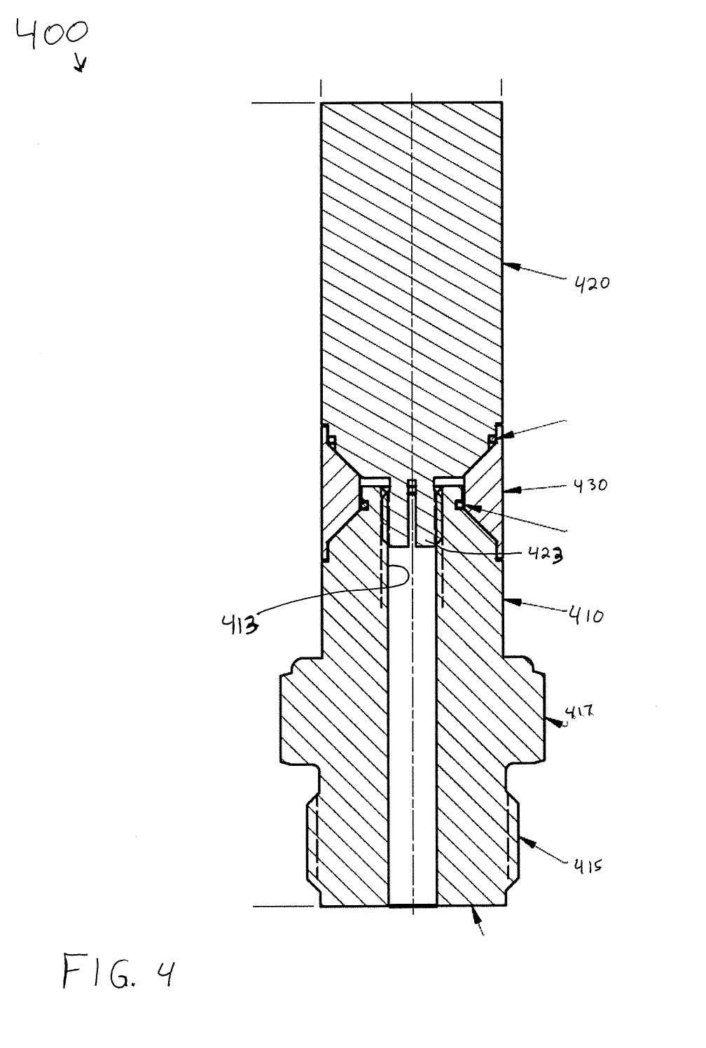

The adapter 210 may include, for example, a central bore 212. Optionally, the bore 212 may include internal treading at the upper end for receiving complimentary threading from either a bolt 240 or a threaded plug (shown in FIG. 4).

The adapter includes an obliquely angled annular end surface 214 on its upper side for mating with a corresponding surface of the tube 230. The surface is preferably angled to face radially outward at an angle matching the angle of the end surface of the tube. The adapter may optionally include a radial groove 216 on an outer diameter of a central axially upwardly extending protrusion that opens up to the obliquely angled annular end surface 214. The groove may receive the filler material used for brazing the adapter to the tube. Optionally, the adapter may include an annular relief 218 at the radially outermost edge of the end surface for receiving a complimentary lip 232 of the tube 230. The interfacing of the lip 232 with the relief 218 may assist in easing the orientation and assembly of the parts.

The adapter may also include a threaded end 215 for threadably engaging a valve block or manifold. The adapter may also include a hexagonal (or other shaped) portion 217 for engaging a wrench or other tool to allow the adapter to be spun into the valve block or manifold.

The plug 220 may include a central bore 222 for receiving a bolt 240 for holding the assembly together. The plug 220 includes a bottom annular axially-outward facing end surface 224 for abutting and joining to a complimentary surface of the tube 230. Optionally, the plug 220 may include an annular relief 226 at the radially outermost edge of the end surface (or immediately radially outward of the groove 228) for receiving a complimentary lip 234 of the tube 230. The interfacing of the lip 232 with the relief 218 may assist in easing the orientation and assembly of the parts. The groove 228 may preferably be located at an axially outermost (and therefore, in this embodiment, radially outermost) location of the annular end surface 224.

The tube 230 includes a pair of respective annular axially-outward facing end surfaces 236 and 238 for mating with corresponding end surfaces of the plug and adapter. Optionally, the tube includes lips 232 and 234 for interfacing with corresponding grooves or reliefs of the adapter and/or plug. As shown, the lips are preferably located at an edge of the annular end surfaces 236 and 238, although other locations are possible. Preferably, the lips are located at radial and axial extremes of the tube. These lips may help align the pieces for assembly and/or keep filler material within the joint. Although no lip is necessary, and one lip is possible, preferably the tube includes two lips and is symmetrical about a horizontal axis in the configuration shown (i.e. is axially symmetrical) so as to make orientation of the tube easier during assembly.

In the exemplary embodiments illustrated, the end surfaces 236, 238 are angled obliquely with respect to the longitudinal axis of the tube assembly. In particular, they are angled so as to be radially-inwardly facing. The angles serve to route the flux through a longer path to direct the flux through the moving armature and not shunt around the inlay area. A 45 degree angle is the most common angle but we are not limited to that. Preferably, the surfaces are angled from between 30 and 60 degrees, although other angles are possible. More preferably, the angle is approximately 45 degrees.

In some embodiments, the nonmagnetic material of the tube is machined from a single piece of material (for example, a solid bar) so that issues with weld porosity of the inlay style tubes are eliminated.

Preferably, the tube portion extends just long enough to prevent the flux from shunting over the gap which reduces force output. In other words, the length is selected so as to force the flux through the moving armature and the plug face.

Filler material (for example, a copper ring or a silver ring) is used to braze the tube with the plug and the tube with the adapter. In exemplary embodiments, the filler material is trapped in a location above the joint to be brazed for both braze locations. The location enables the filler material to melt and flow down into the joint when at the brazing temperature. Through capillary attraction, the molten filler material flows into the bevel joint. Although it is possible for the filler material to flow against gravity (and therefore be located below or within the joint, a gravity fed arrangement improves consistency of the joint.

After the parts are assembled, a bolt is used to keep the parts together and maintain their alignment. The bolt could also be replaced by a clamp device (not shown). Alternatively, gravity could be relied upon without a dedicated coupling device.

Turning now to FIG. 4, an exemplary embodiment of the assembly is shown at 400. The assembly 400 is substantially the same as the above-referenced assembly 200, and consequently the same reference numerals but indexed by 200 are used to denote structures corresponding to similar structures in the assembly. In addition, the foregoing description of the assembly 200 is equally applicable to the assembly 400 except as noted below. Moreover, it will be appreciated upon reading and understanding the specification that aspects of the assemblies may be substituted for one another or used in conjunction with one another where applicable.

FIG. 4 shows that one of the plug or adapter (in this case, plug 420) may include a threaded protrusion 423 for threadable engagement with a threaded receptacle 413 in the other one of the plug or adapter (in this case, adapter 410).

After assembly and securement, the tube assembly may either be placed into a brazing furnace or be brazed with an induction coil to melt the filler material and bond the parts.

The bolt (if used) or other securement device may be removed or machined away along with extra material on inner diameter of the tube. Further, the outer diameter may also be machined to remove excess material. In both cases, this machining may be used to smooth the diameters and/or to remove material that was used to trap the filler material and/or align the parts.

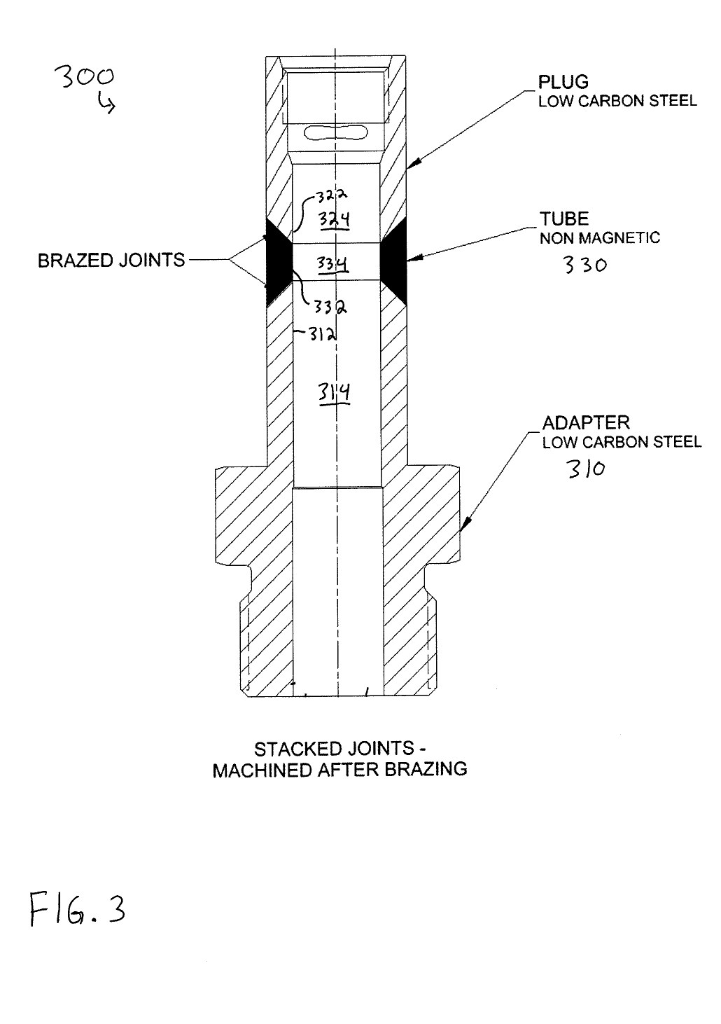

FIG. 3 shows how an exemplary final assembly 300 appears after machining. By machining away the material, the bore runs true with the dissimilar materials and three sections. In other words, the inner surface 312 of the bore 314 of the adapter 310 is aligned with and continuous with the inner surface 332 of the bore 334 of the tube 330, which is aligned with and continuous with the inner surface 322 of the bore 324 of the plug 320 (although the plug need not have a bore in some exemplary embodiments) at least at the tube and portions of the adapter and plug adjacent the tube. In other words, the bores have been machined into one continuous and smooth bore around the tube.

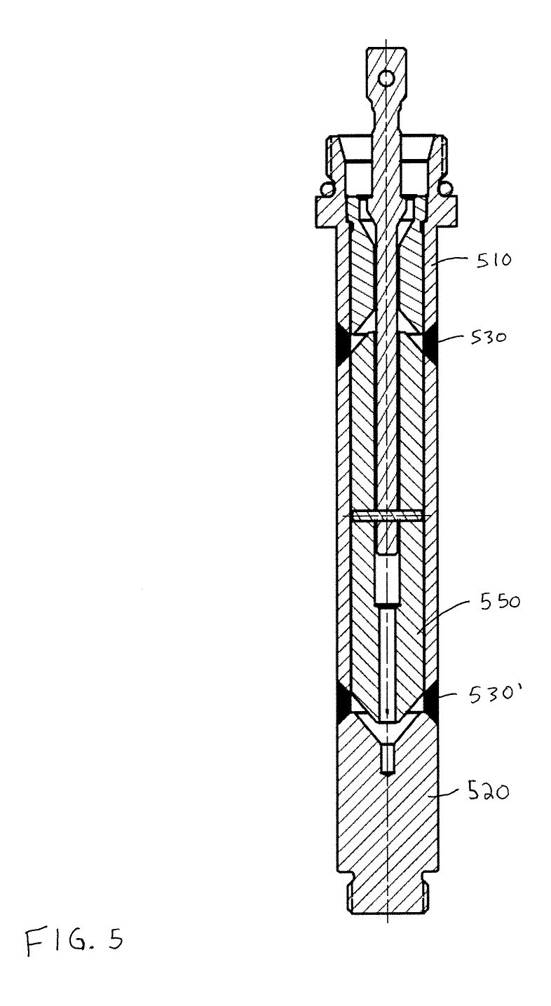

Turning now to FIG. 5, an exemplary embodiment of the assembly is shown at 500. The assembly 500 is substantially the same as the above-referenced assemblies, and consequently the same reference numerals but indexed to a 500-series number are used to denote structures corresponding to similar structures in the assembly. In addition, the foregoing descriptions of the assemblies 200, 400 are equally applicable to the assembly 500 except as noted below. Moreover, it will be appreciated upon reading and understanding the specification that aspects of the assemblies may be substituted for one another or used in conjunction with one another where applicable.

In particular, FIG. 5 depicts a push-pull solenoid type having two axially spaced apart tubes 530, 530′. Because the elimination of the porosity is important, exemplary dual-tube or push-pull solenoids are especially advantageous because it has been found that attempting to do tubes with dual inlay sections is a problem for the conventional welded inlay design. The inlay is typically welded one location at a time. When two inlay sections are needed, the heating from the second location causes a problem for the second section. This problem may be mitigated or solved by exemplary methods using brazing.

As used herein, the term “brazing,” “braze,” and the like are meant to encompass both brazing and soldering. In other words, the inventions should not be considered limited to the technical definition of brazing in which certain temperatures define the difference between brazing and soldering. Similarly, the filler material may be any appropriate brazing or soldering material none in the art and is not limited to copper and silver. Further, the filler material may take any suitable form, and is not limited to a ring. For example, one or more of the following may be used as a filler material: rod, ribbon, powder, paste, cream, wire or preform. Another exemplary filler material is, for example, a cone-shaped washer preform, or a copper or alloy paste which uses a flux based material to hold the copper as it is brushed on prior to assembly. Flux may or may not be used as needed, and may be a part of the filler material or may be separately applied. Further, the heating method employed should also not be limited to the methods discussed herein; the invention is not limited to furnace or induction heating although these are considered exemplary methods. Moreover, the surfaces to be brazed may be cleaned prior to assembly by any method known in the art such, for example, chemical cleaning and/or abrasive/mechanical cleaning.

It is also noted that, although the forms of the tube assembly and it's constituent parts have been depicted herein as cylindrical, the invention is not so limited. For example, square, hexagonal, or other prismatic/extruded shapes may be used. Similarly, the term “tube” herein should not be considered limited to a tube having a circular cross-section; other shapes are also possible, such as, for example, a square or hexagonal shape.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A tube assembly for a solenoid operated cartridge valve comprising:
an adapter having an axially extending central bore along a longitudinal axis of the tube assembly for receiving an armature;
a plug axially aligned with the central bore of the adapter;
a nonmagnetic tube having a central bore along the longitudinal axis and aligned with the central bore of the adapter, the tube having a pair of respective annular axially-facing end surfaces abutting the adapter and the plug, the end surfaces being obliquely angled with respect to the longitudinal axis; and
filler material positioned between and joining the adapter and the tube, and the tube and the plug.

2. The tube assembly of claim 1, wherein an angled end surface of the adapter abuts one of the end surfaces of the tube and extends from an outer diameter surface to an inner diameter surface that defines the bore of the adapter.

3. The tube assembly of claim 1, wherein the annular end faces are angled at 45 degrees with respect to the longitudinal axis.

4. The tube assembly of claim 1, wherein the annular end faces are angled so as to face radially inward towards the longitudinal axis.

5. The tube assembly of claim 1, wherein the filing material is copper.

6-7. (canceled)

8. The tube assembly of claim 1, wherein the tube is austentitic stainless steel.

9. (canceled)

10. The tube assembly of claim 1, further comprising a second tube axially spaced from the other tube, and
wherein the tube assembly is a push/pull tube assembly.

11. A method of making a tube assembly for a solenoid operated cartridge valve, the method comprising:
forming a pre-brazed assembly by assembling in respective axial order an adapter, a tube, and a plug;
brazing the pre-brazed assembly to form a brazed assembly,
wherein the tube includes a pair of respective annular axially-facing end surfaces abutting the adapter and the plug, the end surfaces being obliquely angled with respect to a longitudinal axis of the tube assembly.

12. The method of claim 11, further comprising:
placing filler material on an inner diameter of the tube between the tube and the adapter.

13. The method of claim 11, further comprising:
placing filler material on an inner diameter of the tube between the tube and the plug.

14. The method of claim 11, wherein the filler material is copper.

15. The method of claim 11, wherein the filler material includes a metal ring.

16-17. (canceled)

18. The method of claim 11, wherein the tube is austentitic stainless steel.

19. The method of claim 11, wherein the assembling includes retaining the assembly with a bolt.

20. The method of claim 11 further comprising the step of machining away a retaining bolt.

21. The method of claim 11, wherein the assembling includes retaining the assembly by screwing the plug into the adapter.

22. (canceled)

23. The method of claim 11 wherein the step of forming the pre-brazed assembly further includes trapping the brazing elements above respective joints between the plug and the tube and between the tube and the adapter.

24. The method of claim 11, further comprising machining at least one of the outer diameter or the inner diameter of the brazed assembly.

25. The method of claim 24, wherein machining include smoothing brazed joints between the plug and the tube and between the tube and the adapter.

26. A method of making a tube assembly for a solenoid operated cartridge valve, the method comprising:
forming a pre-brazed assembly by assembling in respective axial order an adapter, a tube, and a plug;
brazing the pre-brazed assembly to form a brazed assembly; and
machining at least one of the outer diameter or the inner diameter of the brazed assembly.

27-37. (canceled)
